(19) United States
(12) Patent Application Publication
(10) Pub. No.: US 2007/0115097 A1
(43) Pub. Date: May 24, 2007

(54) Security key system, method and device

(75) Inventors: Bryan Allan Scott, Austin, TX (US); Kenneth Matthew Glover, Coppell, TX (US); Dennis Keith Pharr, Oklahoma City, OK (US)

Correspondence Address: Intellimatics;Attention Bryan A. Scott, Ste. 210-306, 106 N. Denton Top Rd., Coppell, TX, 75019, US

(73) Assignee: Intellimatics, LLC

(21) Appl. No.: 11/286,533

(22) Filed: Nov. 23, 2005

(51) Int. Cl. B60R 25/00

(52) U.S. Cl. 340/5.73; 340/825.49; 340/5.9

(57) ABSTRACT

The invention is a system that provides a means to open and close a lock using a security key algorithm. The security key algorithm, is a method, that uses location based and time based data to create a unique security key. Once the security key is created, the security key algorithm monitors the security key system's location and opens and closes the lock according to the security key's parameters. The security key device is an object, such as a security container, wherein the security key system is integrated within or is removably attached thereto.

### BACKGROUND OF THE INVENTION

The invention relates to security, and, more specifically the invention relates to transporting assets securely between at least two locations.

### BRIEF SUMMARY OF THE INVENTION

Interpretation Considerations

This section does not describe prior art as defined for purposes of anticipation or obviousness under 35 U.S.C. section 102 or 35 U.S.C. section 103. Thus, nothing stated in the BRIEF SUMMARY OF THE INVENTION is to be construed as prior art

Discussion

Transporting assets securely between at least two locations has been an interest of humankind for centuries. This interest has lead to many inventions ranging from, but not limited to, a simple skeleton key lock on a wooden box transported using a stage coach to a complex metal safe having a combination lock integrated into a vehicle such as an armored truck. Unfortunately, most of these inventions, although they provide additional security, are dependent solely upon a human locking and unlocking a security container with a key or using a combination that has been memorized. Accordingly, the inability to lock and unlock a security container that requires a human solely to use a key or combination may lead to a security breech.

This invention provides technical advantages as a Security Key System that eliminates the need for a human to use a key or combination to open a box or container by using location coordinates and time data from Global Positioning System (GPS) satellites or Assisted GPS (A-GPS) data extrapolated using the cellular networks, as a key to lock and unlock security containers. It should also be noted, that the invention may utilize either GPS or A-GPS and that these technologies may be used interchangeably because both technologies collect GPS latitude and longitude coordinates and time data. Now, preferably the Security Key System is embedded within a portion of a container, however, it may be adapted to be embedded into any object that is transported between two locations, such as a car, boat, airplane, or crate, for example.

The Security Key System has a microprocessor capable of executing a Security Key Algorithm, a bus coupled to the microprocessor, and a port coupled to the microprocessor that is enabled to couple to a lock. The Security Key Algorithm is a method that processes GPS data and determines when the lock should open and close. The Security Key Device is a container that has a Security Key System integrated within that has a switch that is adapted to lock and unlock the container.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWING

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 illustrates depicts a Security Key System;

FIG. 2 illustrates a Security Key Algorithm Method;

FIG. 3 illustrates a Security Key Device;

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the CLAIMS section.

Discussion of the Figures

Accordingly, the invention can be characterized as a Security Key System, Method, and Device. In one embodiment, the invention is a system that provides a means using a security key algorithm to open and close a lock. In another embodiment, the invention is a method that uses a security key algorithm to set key parameters and monitor location and time data to determine when an open lock act shall occur. And in another embodiment, the invention is a device that uses a security key system embedded within a container to open and close a lock.

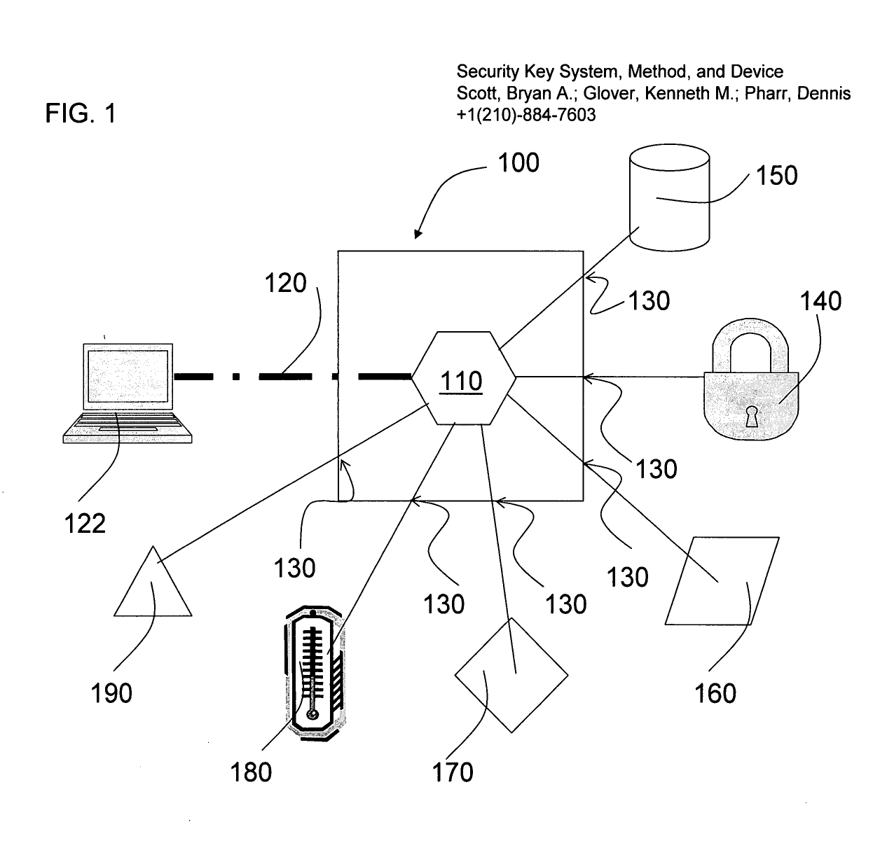

Reference is now made to the figures, and in particular with reference to FIG. 1, which depicts a Security Key System. In a preferred embodiment, the Security Key System 100 comprises a microprocessor 110 capable of executing a Security Key Algorithm, a bus 120 coupled to the microprocessor 110, a port 130 coupled to the microprocessor 110, and a lock 140 coupled to the port 130.

In a preferred embodiment, the Security Key System 100 includes logic (not shown) that is coupled between each port 130 and the microprocessor 110. The bus 120 may be any bus system used in any computer 122 or computer-like device, and is preferably a bi-directional bus such as serial, parallel, card bus, AGP, PCMCIA, PCI, VME, ISA, SCSI, or a wireless bus. Similarly, the bus 120 may be simulated via USB, Firewire, or a network card, for example. The logic is employed to provide additional functionality to the Security Key System 100.

For example, the logic could be a lock opening sequence, thus enabling the Security Key System 100 to open either an electrically controlled or a mechanically controlled lock 140, or other type of lock know to those skilled in the art of making locks. Furthermore, the logic could be a fail safe sequence thus enabling the Security Key System 100 to open the lock 140, in an emergency situation.

Other devices that may be coupled to the microprocessor 110, which may require logic, include a GPS receiver 150, a temperature sensor 160, a barometric sensor 170, a biometric reader 180, or a modem 190. In a preferred example, the modem could be a cellular modem utilizing CDPD, GSM, GPRS, CDMA, 1XRTT, EDGE, UMTS, or other technology known to those skilled in the art of modems. Of course, it should be understood that the devices provided herein are exemplary only, and any type of input or output device that is connectable to any embedded system, or a personal computer is also connectable to the invention. It should also be apparent, that the lock 140 maybe coupled to the bus 120, where interface logic may be used to facilitate a lock opening sequence, for example.

In another embodiment, the invention is a Security Key System 100 having a microprocessor 110 capable of executing a GPS key algorithm, a bus 120 that couples the Security Key System 100 to a computer 122, a port 130 coupled to the microprocessor 110, and a lock 140 coupled to the port 130.

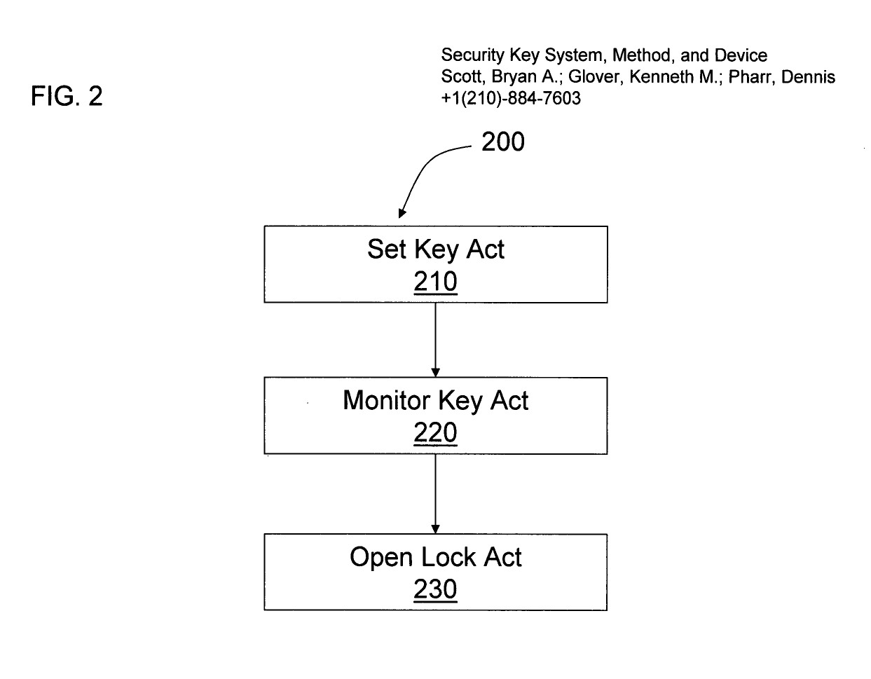

Reference is now made to FIG. 2 which illustrates a GPS Key Algorithm 200 Method. In general, the Security Key Algorithm 200 processes GPS data collected by a GPS receiver, for example, and determines when an open lock act shall occur 230. In a preferred embodiment, the Security Key Algorithm 200 parameters are set through the set key act 210. The set key act 210 is a process by which at least two unique GPS coordinates, geo-fences, or a combination thereof, are defined and two unique times, range of time periods, or combination thereof, are defined. A GPS coordinate comprises a latitude and longitude component. A geo-fence is collection of GPS coordinates within a specified area surrounding a single GPS coordinate or a geo-fence may also be defined as a set of coordinates within a given perimeter that is defined by multiple GPS coordinates. A time is specific time during a 24 hour period, that may be specified in hours only, hours and minutes, or hours, minutes, and seconds, such as 06:01:56 Coordinated Universal Time (UTC). Of course, it is apparent, that time may be represented in various formats and within various time zones, of which all apply to this invention.

Through the set key act 210, for example, a first GPS coordinate is set to a single point of interest, such as a specific room in the New York Guggenheim museum having a time set to 06:00:00 UTC on Feb. 15, 2012 and a second GPS geo-fence is set to an area, such as a 25 meter radius, surrounding a single GPS coordinate that is set to a single point of interest, such as the most central GPS coordinate of the Venice Guggenheim museum having a time period set between 20:00:01. and 20:15:00 UTC on Feb. 15, 2012.

Once the Security Key Algorithm 200 parameters are set, the monitor key act 220 occurs. The monitor key act 220 is a process in which the GPS location and time for the Security Key System 100 are monitored and recorded. The key monitor act 220 determines when the parameters specified in the set key act 210 are met. Once the key monitor act 220 parameters are met, the open lock act 230 occurs. The open lock act 230 is a process that enables the Security Key System 100 to open a lock 140.

In a preferred embodiment, the open lock act 230 would occur after the Security Key System 100 had successfully passed through the specified set key act 210 parameters, such as originating at a specific room in the New York Guggenheim museum at 06:00:00 UTC on Feb. 15, 2012 and reaching its destination within a 25 meter radius that surrounded the most central GPS coordinate at the Venice Guggenheim museum between 20:00:01. and 20:15:00 UTC on Feb. 15, 2012.

Therefore, the Security Key Algorithm 200 is enabling a lock opening sequence, whereby the method comprises setting at least two unique location based and time based parameters through the set key act 210, monitoring location based and time based data from a GPS receiver through the monitor key act 220, and enabling a lock opening sequence when location based and time based parameters are validated through the open lock act 230.

In other embodiments, the set key act 210 may have parameters that specify a plurality of GPS locations and times, such as the Security Key System 100 must successfully pass through six (6) unique geo-fences within six (6) different time periods. It should also be apparent to those skilled in the art, that other parameters in addition to those illustrated above, may be set as part of the set key act 210. Additional parameters, for example, may include a specific temperature or range of temperatures, a specific barometric pressure or range of barometric pressures, specific data from a biometric device, such as a finger print reader or retinal reader, or specific data queried or received from a network such as a alphanumerical password sent from a wireless input device such as a cellular phone, or personal digital assistant.

In yet another embodiment, it should be apparent, that A-GPS may be used, whereby the Security Key Algorithm 200 utilizes A-GPS to determine if a parameter or set of parameters has been met as defined in the set key act 210. A set parameter defined in the set key act 210, may be extrapolated by the monitor key act 220, using A-GPS or GPS. In addition, GPS data may be received or other data may be received by the Security key system 100 through data transport methods such as Internet Protocol (IP) data transfer and through other protocols such as the use of the Short Message Service (SMS) protocol. Further, it is apparent that the invention may use various forms of data transport means that utilize secure socket layer (SSL) encryption or not secure encryption and that use packet data, such as Transmission Control Protocol (TCP)/IP or non-packet data, such as Universal Packet Data (UPD).

It should also be apparent, that a second parameters set in the set key act 210 for either location, time, or both may be changed once a first parameter has already been received by the monitor key act 220. In addition, a third parameter may be set in the set key act 210 once a first parameter has already been received. The order in which the parameters are set and received are dependent on when they are set and they are received, therefore, in an alternative embodiment, yet not preferred embodiment, the monitor key act 220 may occur prior to the set key act 210.

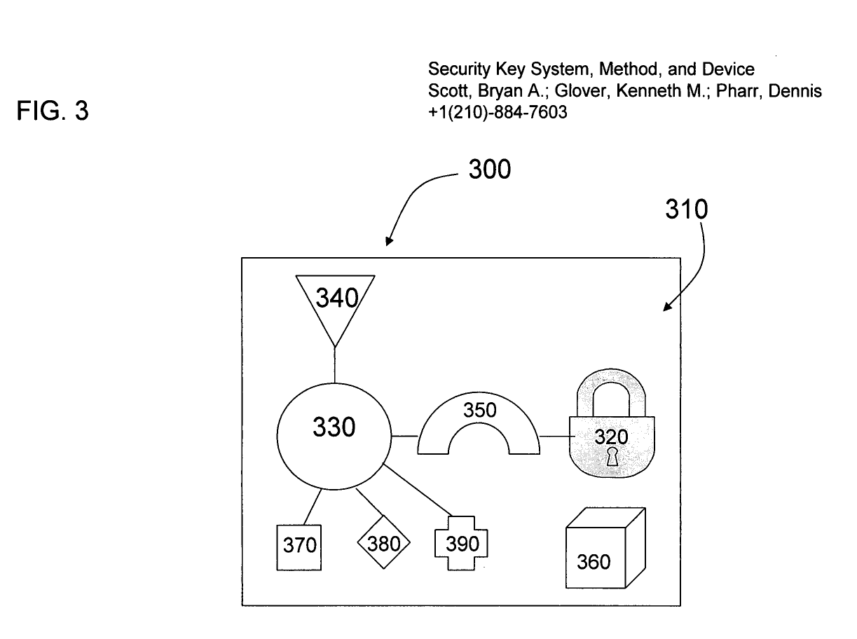

FIG. 3 illustrates a Security Key Device 300 comprising a container 310 having a cavity and a lock 320, a Security Key System 330 adapted to removably attach to a portion of the container 310, a GPS receiver 340 coupled to the Security Key System 330; and at least one switch 350 coupled to the Security Key System 330 that is also adapted to couple to the lock 320. In a preferred embodiment, the container 310 is a briefcase sized box that has a top portion and a bottom portion that are enabled to open and close by a hinge that is located within the container 310. The container is adapted to lock and unlock through the use of a magnets that line the perimeter of the top portion and bottom portion surfaces that removably attach when the container 310 is closed. The magnets lock and unlock by at least one switch 350 that is adapted to couple to the Security Key System 330. In addition, there is a cavity (not shown) within the container 310 where an object 360, such as a painting, a diamond, a gem, or a historical artifact may be stored.

It should be apparent to those skilled in the art of making containers, specifically security containers, that the outermost portion of the container may be covered with a fire proof or bullet proof substance. In addition, it should also be apparent to those skilled in the art of making containers that the inner most portions may be lined with special materials that may protect the object contained therein. Furthermore, it should also be noted, that the container 310 may have a specialized seal to prevent or resist water, moisture, or air from entering or leaving the container 310.

In an alternative embodiment, the Security Key Device 300 may also comprise a wireless modem 370, a biometric reader 380, and a power source 390. The wireless modem 370 may have an embedded antenna that is adapted to be removably attached to any portion of the Security Key Device 300, whether internal to the container 310 are integrated within an external face or portion of the container 310. The biometric reader 380 may also be adapted to be integrated into an external face or any portion of the container 310.

In a preferred embodiment, the power source 390 uses direct current (DC) from rechargeable battery, such as lithium ion, nickel metal hydride, or other known to those skilled in the art of manufacturing rechargeable batteries, including battery technologies that use inductive charging, for example. In alternative embodiments the power source 390 may use DC power from a cigarette lighter receptacle in a vehicle or directly from a lead acid or alkaline battery. In yet another alternative embodiment, the power source 390 may use alternating current (AC) from an AC wall socket.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A Security Key System comprising:
a microprocessor capable of executing a Security Key Algorithm;
a bus coupled the microprocessor;
a port coupled to the microprocessor; and
a lock coupled to the port.

2. The system of claim 1 wherein the port is a serial port.

3. The system of claim 1 wherein the lock is electrically controlled.

4. The system of claim 1 wherein the lock is mechanically operated.

5. The system of claim 1 wherein the port is electrically coupled to a GPS receiver.

6. The system of claim 1 wherein the port is electrically coupled to a modem.

7. The system of claim 6 wherein the modem is a GSM modem.

8. A Security Key Algorithm enabling a lock opening sequence, the method comprising:
setting at least two unique location based and time based parameters;
monitoring location based and time based data; and
enabling a lock opening sequence when location based and time based parameters are validated.

9. The method of claim 8 further comprising monitoring location based and time based data from a GPS receiver.

10. The method of claim 8 further comprising monitoring location based and time based data from an A-GPS receiver.

11. The method of claim 8 wherein the lock opening sequence generates an electrical signal.

12. The method of claim 8 wherein the location based and time based data is contained within a GPS data string.

13. A Security Key Device for securely transporting assets comprising:
a container having a cavity and a lock;
a Security Key System having a Security Key Algorithm adapted to removably attach to a portion of the container;
a GPS receiver coupled to the Security Key System; and
at least one switch coupled to the Security Key System that is adapted to couple to the lock.

14. The device of claim 13 wherein the container is fire resistant.

15. The device of claim 13 wherein the container comprises a biometric reader.

16. The device of claim 13 wherein the container comprises a temperature sensor.

17. The device of claim 13 wherein the container comprises a barometric sensor.

18. The device of claim 13 wherein the container comprises a modem.

19. The device of claim 13 wherein the container comprises a biometric reader.

20. The device of claim 13 wherein the container comprises a biometric reader.
